(19) United States
(12) Patent Application Publication
(10) Pub. No.: US 2025/0353679 A1
(43) Pub. Date: Nov. 20, 2025

(54) HIGH-DENSITY AUTOMATED STORAGE AND RETRIEVAL SYSTEM HAVING PSEUDO-CONTINUOUS MOTION

(71) Applicant: CARNEGIE MELLON UNIVERSITY, Pittsburgh, PA (US)

(72) Inventors: HERMAN HERMAN, Pittsburgh, PA (US); GABRIEL GOLDMAN, Pittsburgh, PA (US)

(73) Assignee: CARNEGIE MELLON UNIVERSITY, Pittsburgh, PA (US)

(21) Appl. No.: 18/873,955

(22) PCT Filed: Jul. 26, 2023
(86) PCT No.: PCT/US23/28687

§ 371 Date: Dec. 11, 2024

Related U.S. Application Data
(60) Provisional application No. 63/392,677, filed on Jul. 27, 2022.

(51) Int. Cl. B65G 1/04

(52) U.S. Cl. CPC B65G 1/0478

(57) ABSTRACT

Disclosed herein is a high-density storage system comprising a plurality of layers, each layer comprising a plurality of rows for storing a plurality of coupled totes and one or more carriers located on opposite ends of each layer, each carrier being multiple rows wide, each carrier capable of retrieving totes from a row in the layer, depositing a tote into a row or oral in a layer and shifting totes from one row to another within the layer.

### BACKGROUND

Companies are pushing to maximize the storage density and efficiency of automated storage and retrieval systems (AS/RS) in their order fulfillment process. AS/RS systems use automated carriers that typically move either between or on top of structures that hold products or totes filled with products. In the case of systems where carriers move in between aisles of products and/or totes, there is a limit as to how dense the system can be in that the space required for the carrier movement reduces the overall potential storage density of the system.

Some systems maximize density by stacking products or totes vertically, which maximizes storage density, but has potentially lower efficiency when retrieving products or totes that are buried lower in the stacks. In one case, a gantry services a range of totes that are stacked on the floor, which minimizes infrastructure but ultimately has a limit on performance based on a limited number of gantry arms overlapping the same workspace. In another case, the system stacks totes vertically within a raised structure. Retrieval robots lift the totes from the top one-by-one. This results in a limit on performance to retrieve totes that are lower in the stack with each lift taking a longer amount of time proportional to the height of the tote stack or product being lifted.

### SUMMARY OF THE INVENTION

The embodiments described herein provide the capability for a highly dense storage solution while also providing a high level of performance, thereby improving both density and speed of retrieval over prior art systems. Instead of stacking the totes vertically (which has an inherent height limit due to the mechanical limit and the weight of the totes), the totes are arranged in horizontal layers of rows within a passive supporting structure. Unlike other systems, the totes are mechanically coupled to allow for a row of horizontally connected totes to be pulled and/or pushed together as a unit by pulling or pushing one or more totes on the end of a row, which will also pull or push all other totes within that same row that are connected to each other. This arrangement allows any totes within a row to be retrieved by repeatedly pulling and decoupling the outer tote or totes from the row until the right tote is retrieved. It also allows for the easy storage of totes. A tote could be stored in this AS/RS system simply by pushing a tote into a row that has an empty spot. As that tote is pushed into that row, it will automatically couple itself longitudinally when it comes into contact with the totes that are already in that row. This efficient storage approach could also be used to store totes that were removed from a row to access a tote-of-interest initially located on the interior of a row for retrieval.

The described embodiments store totes within a layered support structure. This structure supports the weight of all totes as well as providing rows within the structure in which totes can be stored. The totes are placed into the structure rows through a horizontal motion in a similar manner to other rack-based storage solutions. The novel storage structure allows for a high number of totes to be stored in a single row, whereas more standard rack structures allow for only a small number of totes or packages to be stored on a given shelf, because there is no efficient way to access totes that are located deep in the row. The described embodiments are able to retrieve totes from anywhere within a row upon request with a high level of performance in comparison to other high-density storage solutions. This is possible since all totes, no matter how deep they are located in the row, could be accessed just by pulling on the outside totes until the tote-of-interest is at the edge of the row. Pulling on the outer tote or totes will also pull all the other totes that are coupled, thereto allowing the tote-of-interest to be pulled toward the end of the row for retrieval.

In one embodiment, disclosed herein is a piecewise retrieval sequence for connected totes within a storage structure as well as the continuous retrieval sequence for connected totes that features motion of connected totes into or out of a row at a constant velocity. Once a tote is moved onto a carrier, it is shifted to a target row in a piecewise, non-continuous, manner in a direction orthogonal to the source row. Once the tote is aligned with the target row, it is accelerated into the row and couples with totes already in the row and thereafter moves at the same constant velocity as the totes in the row.

The disclosed invention comprises three different types of drives for moving the totes. A constant velocity drive mechanism is responsible for moving the totes into and out of the rows at a constant velocity. An acceleration drive mechanism is responsible for accelerating a tote from the carrier into a row such that it “catches up” to the tote at the end of the row and couples with it, as the row is moving away at a constant velocity. The third type of drive is a side shift drive mechanism that is responsible for shifting the totes on the carrier from a source row to a destination row.

In other aspects of the invention, different features for improving the efficiency of the storage structure are disclosed. These include, for example, various configurations of the three different types of drives, a cantilevered area in the storage structure which allows the continuous drive to be positioned between the layers, improvements to the storage structure to optimize the intake of totes into the system and the output of totes from the system and improvements to the latching mechanism by which the totes in each of the rows are connected to each other.

### BRIEF DESCRIPTION OF THE DRAWINGS

FIG. 1 is an illustration showing an exemplary configuration of the storage system of the present invention.

FIG. 2 shows more detail of a portion of the storage system shown in FIG. 1.

FIGS. 3a-3l is a series of schematic diagrams showing the pseudo-continuous movement of the totes is here shifted from one row to another.

FIG. 4 is a transparent illustration of a tote in accordance with the present invention.

FIG. 5 shows one embodiment of a tote coupling mechanism.

FIG. 6 is an illustration of one embodiment of the carrier.

FIG. 7 is an illustration of a constant velocity drive mechanism in accordance with the present invention

FIG. 8 is an illustration of the lifting mechanism which is part of the constant velocity drive mechanism.

FIG. 9 is an illustration showing a carrier which is moved underneath a cantilevered portion of a row in the storage structure.

FIG. 10 is an illustration of the acceleration drive mechanism.

FIG. 11 is an illustration of internal portions of the acceleration drive mechanism.

FIG. 12 is a side view of the internal structure of the acceleration drive mechanism, showing the configuration of the drive belt

FIG. 13 is an illustration of the side shift mechanism.

FIG. 14 is an illustration of a portion of the storage structure showing the area where the intake/output structure is located.

FIG. 15 is an illustration showing the intake/output structure in situ on the storage structure

FIG. 16 is an illustration of an input ramp which is part of the intake/output structure.

FIGS. 17a-17b are illustrations of the lifting mechanism for lifting a tote from the picking area to an input ramp.

FIG. 18 is a top view of a picking station and an intake and output ramp.

FIGS. 19-20 are illustrations of an intake/output structure showing output buffer ramps, input buffer ramps, and vertical conveyor.

FIG. 21 is an illustration of a carrier showing multiple ways of loading and unloading a tote for intake into or output from the storage system.

FIG. 22 is an illustration of the transfer of a tote from a first carrier to a second carrier.

FIG. 23 is an illustration of the movement of a tote from a row in the storage structure to an output row via a carrier.

FIG. 24 is an illustration of the use of conveyors disposed on the ends of the storage structure for the output of totes from the storage system, wherein carriers are used to transfer the totes from the storage system to the conveyors.

FIG. 25 is an illustration of the use of conveyors for intaking totes into the storage system, wherein the totes are transferred from the conveyor to the storage system via the carrier using a pusher mechanism.

FIGS. 26a-26g are illustrations of the steps of a process of moving a tote from the conveyor to a carrier utilizing a push mechanism.

FIGS. 27a-27e are illustrations of the steps of a process of moving a tote from the conveyor to a carrier using a pusher mechanism, wherein t carrier utilizes a stopping plate to stop the motion of the tote along the conveyor.

FIG. 28 is an illustration of the components for utilizing a stopping plate to align the tote with the carrier, wherein the components are attached to and mobile with the carrier.

FIG. 29 is an illustration of a configuration utilizing segmented carriers, wherein the carrier can transfer totes and move between the segments of the conveyor.

FIGS. 30a-30b are illustrations of carriers which are integrated with the belt portion of the conveyor such as to allow free movement of the carrier along the conveyor and further wherein multiple carriers are utilized on a single conveyor.

FIGS. 31a-31b and FIG. 32 are illustrations of one embodiment of a retention mechanism.

FIGS. 33a-33f are illustrations of the operation of a shifting mechanism for shifting a single tote from a first to a second position.

### DEFINITIONS

As used herein, the term “carrier” refers to a locally or remotely controlled robotic or mechanism capable of moving about a tote support and storage structure in a vertical, horizontal or both directions and capable of accepting, carrying and discharging one or more totes from a source row to a destination row or from an intake of the storage structure or to an output of the storage structure.

As used herein, a “tote” refers to a device capable of carrying goods for transport by a carrier from one location to another. The tote may be configured to be manipulated by a carrier for purposes of movement from a storage location to and from an exit or entry point of the storage system. The tote may be configured as a container or as a flat structure on which other containers may be placed.

As used herein, the term “storage structure” refers to a structure for storing totes and facilitating the placement and retrieval of totes within the storage structure by a carrier.

As used herein, the term “layer” refers to multiple rows for the storage and retrieval of totes. Layers can be oriented in a horizontal, vertical, or any orientation within the storage structure.

As used herein, a “row” is defined as a portion of a storage structure capable of storing a plurality of totes aligned longitudinally with each other and able to move in the longitudinal direction of the row. A row may be horizontal, vertical, or any orientation within the storage structure, but horizontal orientation is the preferred embodiment, because the force to pull a row of totes in the horizontal direction is significantly less than the force needed to lift the coupled totes in vertical direction.

As used herein, the term “constant velocity”, with respect to the movement of rows of totes, is defined as the movement of a row at a substantially constant speed after being accelerated from a stopped position or before being decelerated to a stopped position.

As used herein, the term “conveyer”, is defined as any system capable of moving objects from one place to another, as, for example, using belts, rollers or any other means. A conveyer could operate independently from a mobile carrier or as part of the mobile carrier. A mobile carrier could be considered a conveyer.

### DETAILED DESCRIPTION

The embodiments described herein utilize multiple carriers that work in unison to manipulate totes or other stored product from a storage structure, to efficiently retrieve a particular tote or store a tote. The process utilizes a system of totes or carriers that allow for force to be shared between a row of totes in a singular linear direction (in either positive or negative direction) but also allows for the totes to be decoupled by moving them in a direction orthogonal to the direction of the longitudinal axis of the row (either positive or negative direction). The novel technology can manipulate the totes or other products in both directions to move a target tote (and as a result, all totes coupled to the target tote) toward an end of the row where it may be decoupled from the row.

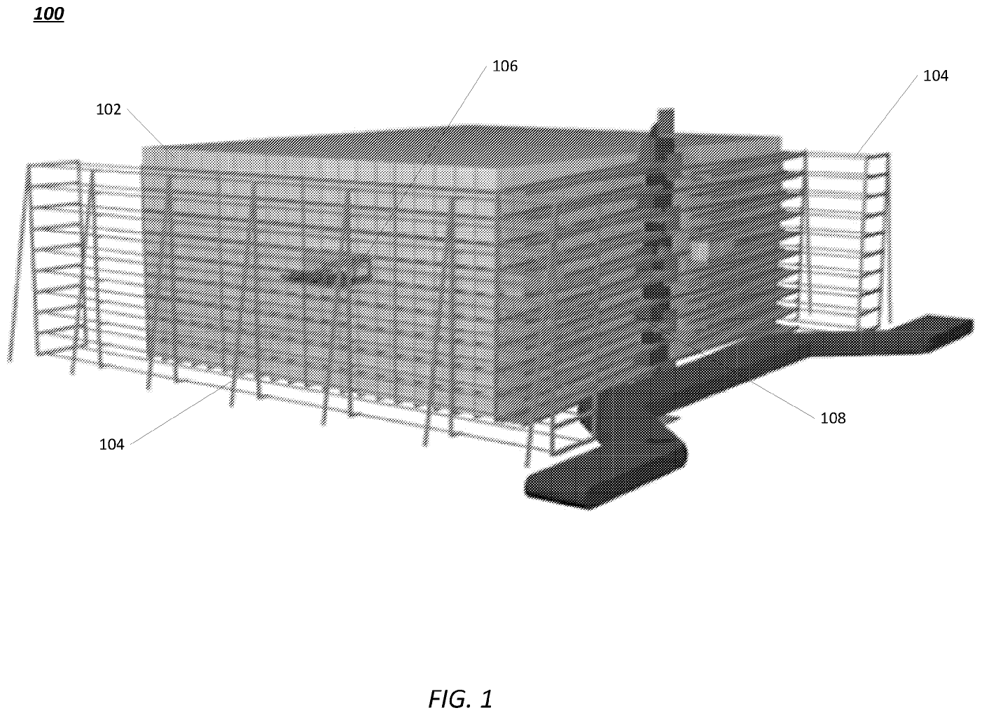

An exemplary storage structure 100 is depicted in FIG. 1. The structure consists of multiple layers of rows 102 containing totes, wherein the totes in each row 102 are coupled to each other to allow movement of the entire row by providing a pushing or pulling force on the tote at the end of the row. Carrier servicing area 104, disposed along opposite sides of the storage structure 100, guide one or more carriers 106 to the ends of rows 102 where the totes are to be manipulated. An intake/output structure 108 may be disposed anywhere within or outside of the structure 100 to facilitate the intake of totes into the system and the output of totes from the system. FIG. 1 shows only one possible embodiment of the system; many variations of the structure and configuration are possible and are considered to be within the scope of the invention.

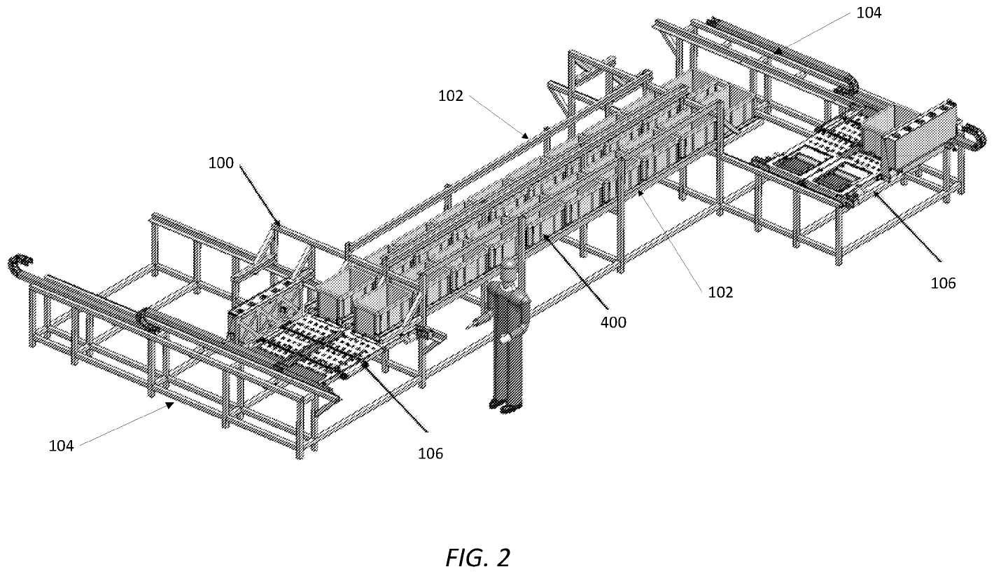

FIG. 2 shows a portion of storage structure 100. The portion shows two rows 102 containing only ten totes 400 per row. However, as would be realized by one of skill in the art, the length of each row 102, and therefore the number of totes 400 that may be stored in a row 102, may be limited only by the ability of the drives to provide the pushing or pulling force necessary to move the entire row of totes, including the weight of the goods contained in each tote. Carriers 106, disposed at either end of the rows 102 may move along carrier servicing area 104 such as to align with rows in the structure 100. Carriers 106 include three types of drive mechanisms which provide the forces necessary to shift totes 400 between rows of storage structure 100. These include the constant velocity drive mechanism 602, the acceleration drive mechanism 604 and the side shift mechanism 606. The various types of drive mechanisms will be discussed in more detail later.

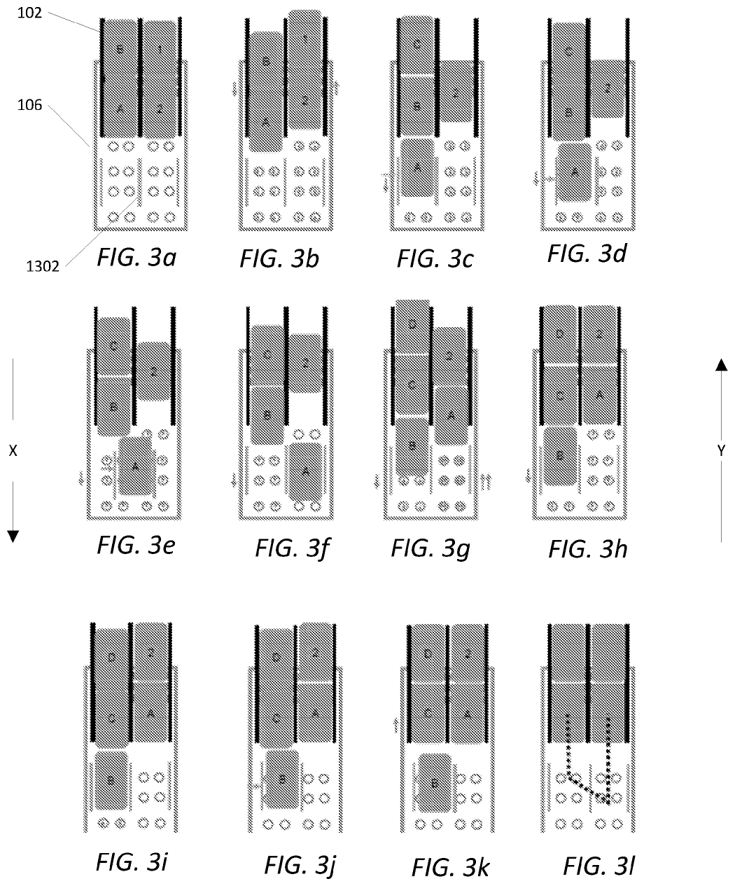

FIGS. 3(a-l) are schematic illustrations of the process by which totes are shifted from one row to another using the pseudo-continuous motion of the present invention. The box labeled 106 in FIG. 3a represents carrier 106 in all of FIGS. 3(a-l) and the lines between the totes represent rows 102. The series of illustrations will show the movement of totes labeled “A” and “B” from the left row to the right row. FIG. 3a shows carrier 106 in position at the end of two rows of storage structure 102. A constant velocity drive mechanism located in carrier 106 engages tote “A” and as shown in FIG. 3b, provides a pulling motion which moves the entire left row in direction “X”. At the same time, or at a pre-determined time thereafter, a carrier on the opposite end of the rows 102 engages a tote at the end of the right row and moves the entire right row in direction “Y”. The movement of the left row in direction “X” and the movement of the right row in direction “Y” occur at a constant velocity. FIG. 3c shows tote “A” clear of storage structure 102 and completely on the carrier. Once the tote is clear of the storage structure 102 the tote is free to be shifted from one row to another. Totes are shifted from one row to another using a side shift drive mechanism the details of which will be discussed later. In addition, totes can be moved in direction “X” or “Y” while on the carrier via the acceleration drive mechanism, which will also be discussed later. As tote “A” is being pulled from the left row by the constant velocity drive mechanism, the acceleration drive mechanism on both the left side and right side of the carrier matches the speed and direction of the constant velocity drive mechanism. In FIG. 3d, tote “A” has begun its shift from the left row to the right row.

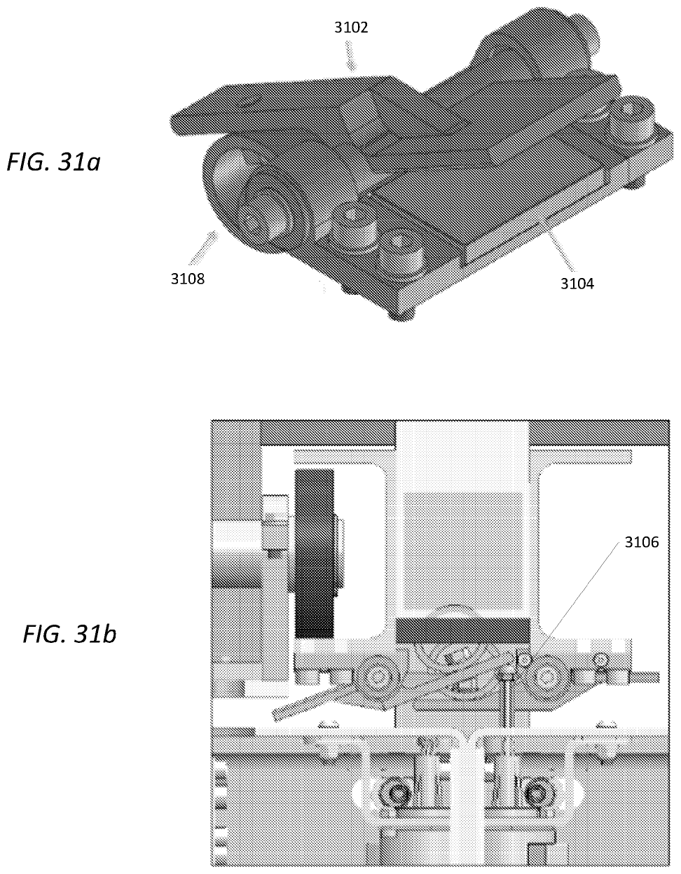

The process of shifting in a direction orthogonal to the row automatically decouples tote “A” from the left row, as will be discussed later. FIG. 3e shows tote “A” at the halfway point between the left row and the right row, while still maintaining a constant velocity and direction “X”. In FIG. 3f, tote “A” is completely aligned with the right row and the acceleration drive mechanism on the right side of carrier 106 reverses direction and accelerates tote “A” in direction “Y” at a faster rate than the constant velocity drive mechanism is pulling the right row in direction “Y”, such that tote “A” catches up with the right row and couples to tote “2”. The actual path of the tote as it moves from the left row to the right row shown in FIG. 31. Of particular interest is the diagonal motion of tote “A” as it moves from the left row to the right row on the carrier 106. Also note, as shown in FIG. 3f, tote “B” is almost out of the left row and positioned on carrier 106. As shown in FIG. 3g, tote “B” enters the left side of carrier 106 as tote “A” is exiting carrier 106 and being moved into the right row. FIGS. 3(h-k) show the same processes as described above for moving tote “B” into the right row.

Note that once tote “B” is completely aligned with the right row, the constant velocity drive mechanism and acceleration drive mechanism on the left side of the carrier cease movement to avoid pulling tote “C” out of the left row. The pseudo-continuous motion provided by the different types of drives on carrier 106 optimizes the efficiency of the movement of the totes into and out of the rows to provide access to a tote-of-interest located on the interior of the rows in a more efficient manner.

### Tote Configuration

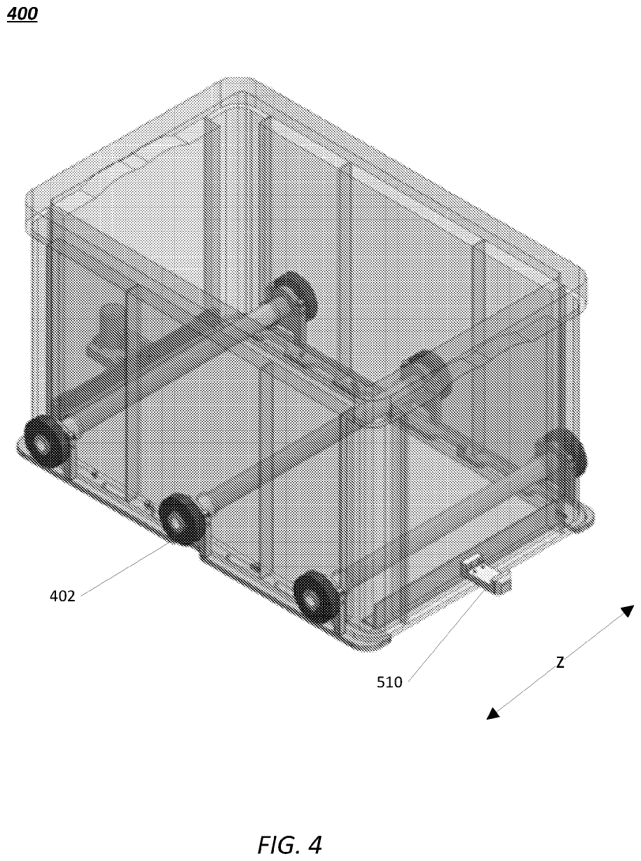

The configuration of totes 400 will now be discussed. A first embodiment of the tote is shown in FIG. 4, wherein the tote embodies a container structure 400 for accepting goods for storage. In an alternate embodiment of the invention, tote 400 may be configured as a flat platform which can accept goods or containers for goods stacked thereon.

As shown in FIG. 4, tote 400 is configured with a series of wheels 402 on opposite sides thereof to allow movement of the tote along a longitudinal axis of each row 102. In one embodiment, shown in FIG. 4, wheels 402 are mounted above the bottom surface of tote 400 and engage parallel tracks disposed on either side of each row 102. In one embodiment, the tracks may be “C-shaped” at support the wheels 402 in both the up and down directions. In another embodiment, not shown, wheels 402 may be disposed near the top surface of tote 400 and would engage the parallel tracks such that tote 400 would hang from the track. In such cases, the tote may be configured as, for example, a flat carrier having a mechanism to engage hanging goods such as clothing. In some embodiments, the wheels may be disposed not on the totes, but in the rows of storage structure 100, wherein the totes ride on the wheel in the rows. IN yet other embodiments, other means may be employed to minimize frictional between the totes and storage structure 100.

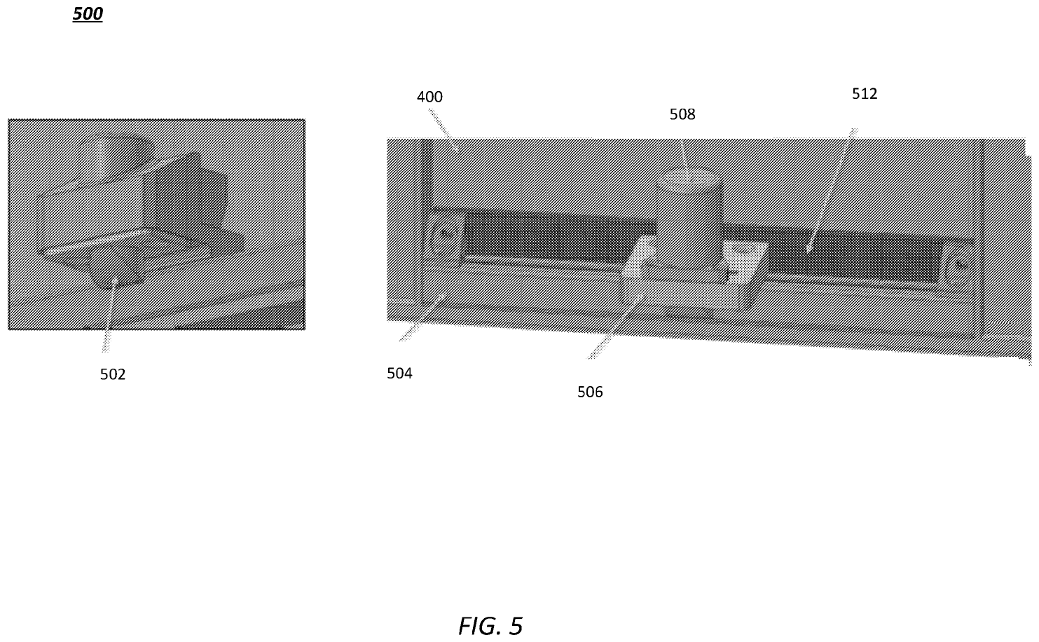

In a second aspect of the invention, totes 400 are configured with a coupling mechanism 500 that automatically engages as totes 400 are moved together. FIG. 5 shows one embodiment of the coupling mechanism. In this embodiment, a first portion of the coupling mechanism 500 comprises a spring-loaded latch 502 having an angled surface that pushes up when the spring-loaded latch 502 encounters a hook mechanism 510, shown in FIG. 4. In one embodiment, coupling mechanism 500 is securely attached to the body of tote 400 via a mounting plate 506 which is securely attached to support structure 504 which in turn is attached to the body of tote 400. Coupling mechanism 500 may include a dust cover 508 and the spacing may be adjusted utilizing a spacer 512 to reinforce the tote wall. In other embodiments of the tote, other configurations are possible. For example, the entire coupling mechanism support structure could be part of the molded plastic from which the tote is constructed.

De-coupling of totes 400 occurs when one tote is moved in a direction orthogonal to the longitudinal line of the row 102, that is, tote 400 is moved towards another row 102 in storage structure 100. As noted in FIG. 4, the edges of hook mechanism 510 are not closed (like the edge portion) such that movement of the tote in either direction indicated by the arrow “Z” will cause hook mechanism 510 to disengage from spring-loaded latch 502, thus decoupling the totes. Thus, as the tote moves from one row to another row, as shown in FIGS. 3(d-e), the tote is automatically decoupled from the adjacent tote in the row. By the time the tote has reached position shown in FIG. 3(e), the tote is completely decoupled from the adjacent tote.

In one alternate embodiment, the totes may be configured with a coupling mechanism 500 and a hook mechanism 510 on each side of the tote, such that the totes may be bidirectionally inserted into and removed from rows 102.

As would be realized by one of skill in the art, the coupling mechanism 500 and hook mechanism 510 just described are only exemplary in nature, and that many other possible mechanisms for coupling and decoupling the totes are contemplated to be within the scope of the invention.

### Carrier Configuration

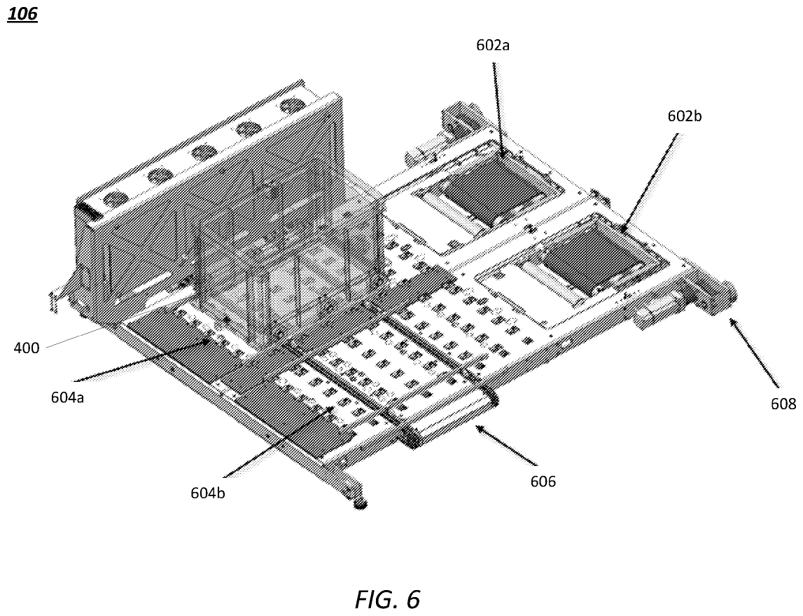

An exemplary configuration of carrier 106 is shown in FIG. 6. In this embodiment, carrier 106 is two rows wide, with one side spaced such as to receive a tote 400 from one row 102 and the other side spaced such as to deposit the tote 400 in an adjacent row 102. In other embodiments of the invention, the carriers may be multiple rows wide, with each row configured as shown in FIG. 6. In an extreme embodiment, carrier 106 may be configured to cover the entire length of the edge of storage structure 100. In yet another embodiment, carriers 106 may be configured to transfer a tote 400 from one carrier 106 to an adjacent carrier 106.

The carrier may be configured with constant velocity drive mechanisms 602a, 602b. Constant velocity drive mechanisms 602a, 602b are bi-directional drives which are configured to engage the end tote in a row 102 such as to pull a series of coupled totes 400 from the row 102 or to push a series of coupled totes 400 into the row 102, depending on the direction of motion of the conveyor belt. In various embodiments, the engagement between the constant velocity drive mechanisms and the totes may be a frictional engagement or may be a positive engagement, for example, with a rack and pinion arrangement. Preferably, constant velocity drive mechanisms 602a, 602b pull the totes 400 from a row 102 or push the totes 400 into row 102 at a constant velocity which is the same for both of constant velocity drive mechanisms 602a, 602b.

Carrier 106 is also configured with acceleration drive mechanisms 604a, 604b, one for each of the rows 102. Acceleration drive mechanisms 604a, 604b are bi-directional drive mechanisms capable of moving totes 400 at a velocity equal to constant velocity drive 602a, 602b, or to accelerate a tote 400 such as to couple it to an adjacent tote 400 that is being moved into a row 102, in which case, the tote must be accelerated to a speed faster than the speed of the constant velocity drive mechanism.

Lastly, carrier 106 is provided with a side shift drive mechanism 606 which is capable of moving totes 400 from one row to another, even as they are being moved in a direction parallel to a longitudinal line of each row 102.

In some embodiments, carrier 106 may be provided with a carrier drive 608 capable of moving carrier 106 within carrier servicing area 104 to align carrier 106 with different rows 102 of storage structure 100. In some aspects of this embodiment, the carrier 106 may be limited to movement within one layer of storage structure 100. In other aspects of this embodiment, the carrier 106 may be configured with a drive mechanism capable of moving carrier 106 between layers of storage structure 100.

Carrier 106 may be provided, in various embodiments, with a plurality of sensors both for providing an identification of a tote 400 via, for example, a barcode mounted on the tote 400, and for sensing the position of a tote 400 on carrier 106.

### Constant Velocity Drive Mechanism

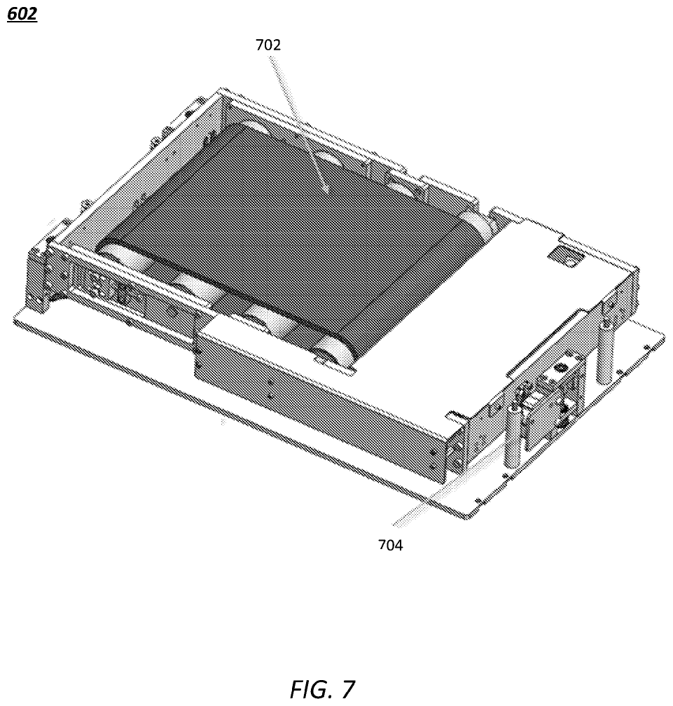

Constant velocity drive mechanism 602, shown in perspective view in FIG. 7 is designed to move totes 400 from a row 102 at a constant velocity onto carrier 106 and to move totes 400 on carrier 106 into a row 102 at a constant velocity. Keeping the row of totes 400 moving at a constant velocity saves energy and time that would otherwise be used in accelerating and decelerating the row as totes are removed from or inserted into a row 102. As such, the source row and a target row are in constant motion until a tote-of-interest is retrieved from the interior of the source row and is positioned on carrier 106.

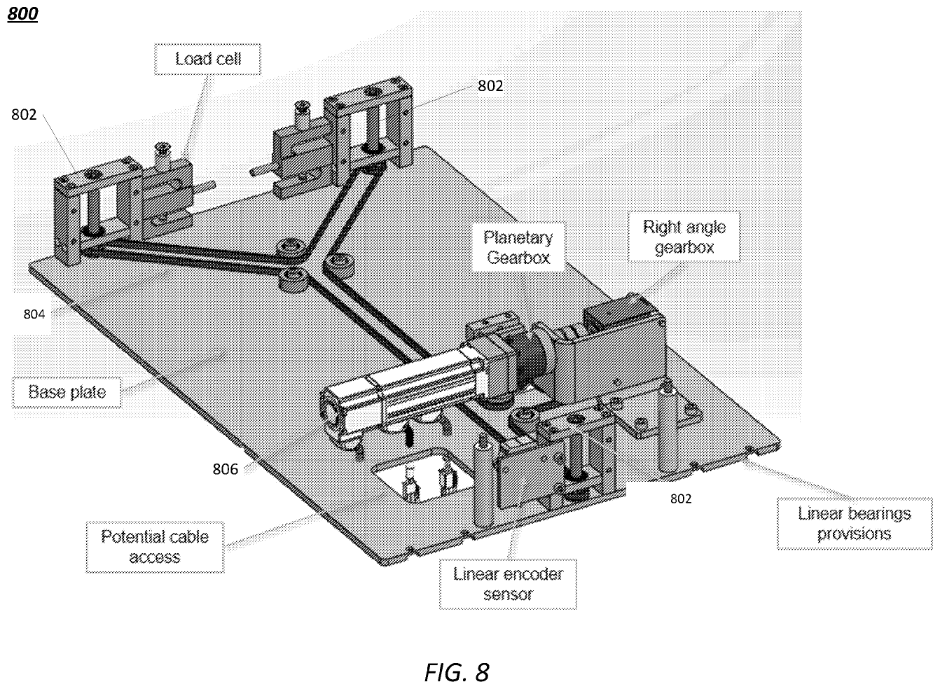

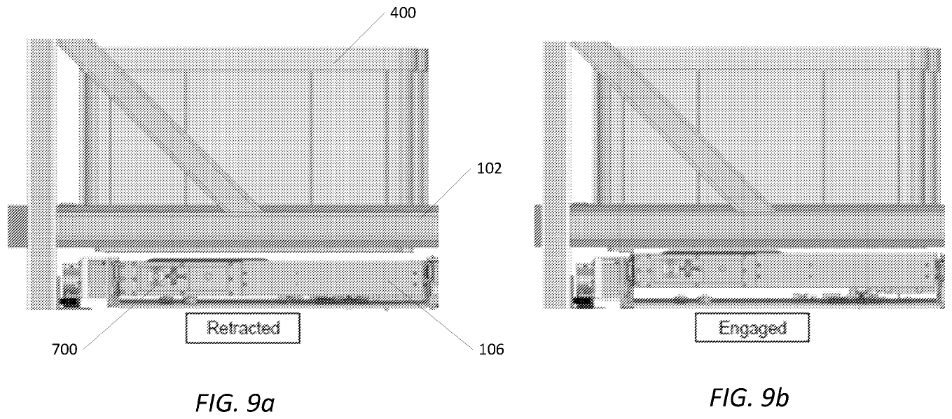

The constant velocity drive mechanism 602 engages a tote by lifting conveyor 702 into frictional contact with the bottom surface of tote 400. Drive mechanism 704 drives conveyor 702 at the constant velocity once the frictional engagement with tote 400 has been made. FIG. 8 shows a lift mechanism 800 for raising the conveyor 702 into frictional contact with the bottom of tote 400. In one embodiment, the lift mechanism 800 consists of three ball screws 802, driven by belt 804. When belt 804 is actuated by motor 806, ball screws 802 are rotated and move upward, thereby lifting conveyor 702 upward and into frictional contact with tote 400. FIG. 9a shows the constant velocity drive mechanism 602 disengaged from tote 400, while FIG. 9b shows a constant velocity drive mechanism 602 frictionally engaged with tote 400. In various other embodiments, other lift mechanism configurations may be used. For example, a cam-based lifting mechanism could be used. In one embodiment, the entire carrier could act as the lifting mechanism to lift the constant velocity drive mechanism into engagement with the tote. In alternate embodiments, the constant velocity drive mechanism 602 may engage a tote via a mechanical engagement.

It should be noted that rows 102 are cantilevered out from storage structure 100 such that carrier 106 can move underneath the cantilevered portion of each row 102 to engage the tote 400 at the end of the row 102. FIGS. 9(a-b) shows carrier 106 with the constant velocity drive mechanism 602 portion of the carrier 106 located underneath the cantilevered portion of rows 102 such that when conveyor 702 is lifted, it frictionally engages the bottom surface of tote 400 at the end of the row.

### Acceleration Drive Mechanism

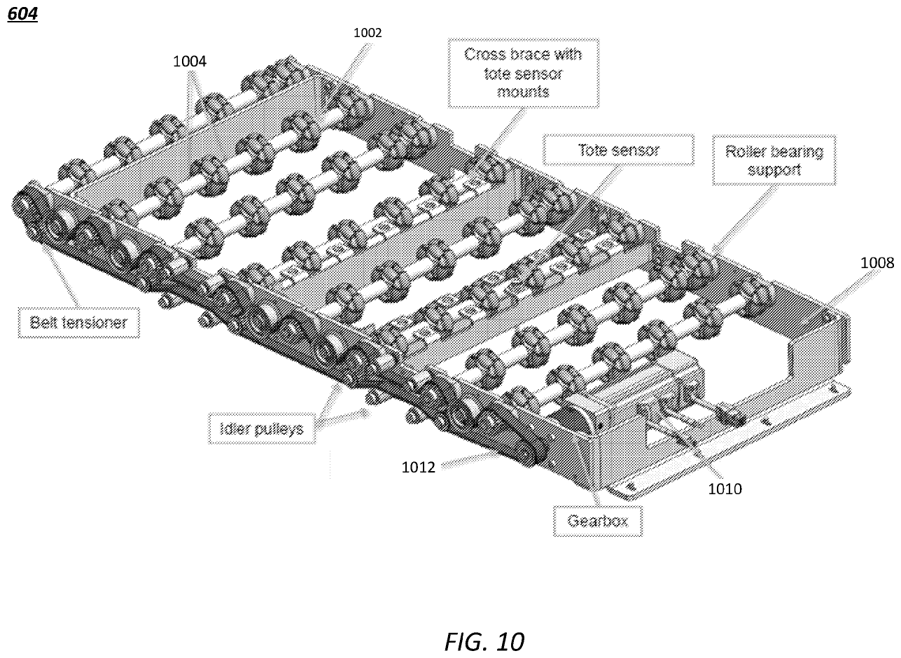

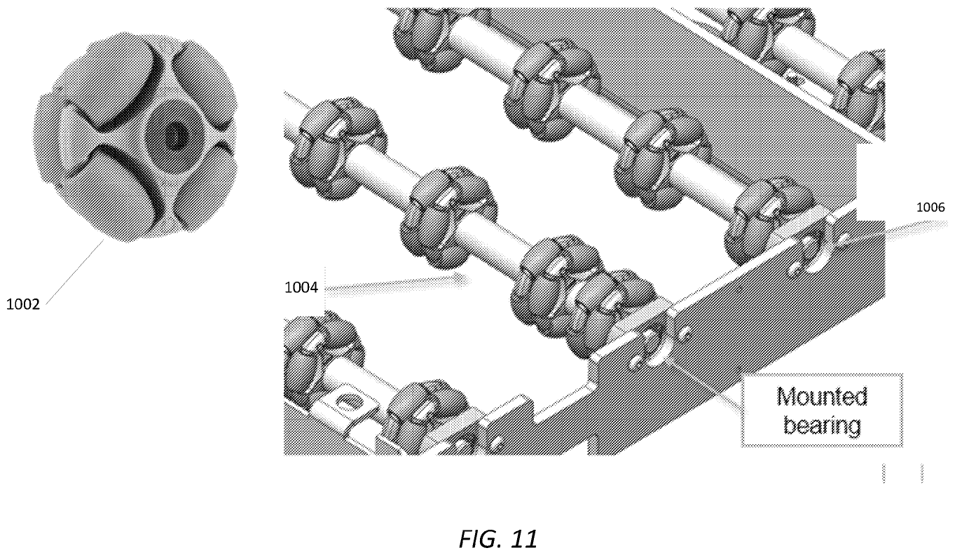

Acceleration drive mechanism 604, shown in FIG. 10 and FIG. 11 consists of a series of Omni casters 1002 mounted in pairs on axles 1006 and separated by spacer tubes 1004. Omni casters 1002 are commercially available off-the-shelf components which, when rotated, engage the bottom surface of tote 400 to move it in the direction parallel to the longitudinal lines of each row 102 of storage structure 100. Axles 1006 are mounted in frame 1008 and driven by motor 1010 via belt 1012. Acceleration Drive mechanism 1000 is bidirectional in that it can accelerate totes 400 in either direction.

Omni casters 1002 also allow a near-frictionless side-to-side motion of totes 400 as they are being accelerated away from a source row 102 or towards a target row 102. This allows the tote 400 to follow the diagonal path shown in FIG. 3(I). In one embodiment, omni casters 1002 are provided in pairs such that the tote is always in contact with the portion of an Omni caster 1002 to allow the side-to-side motion.

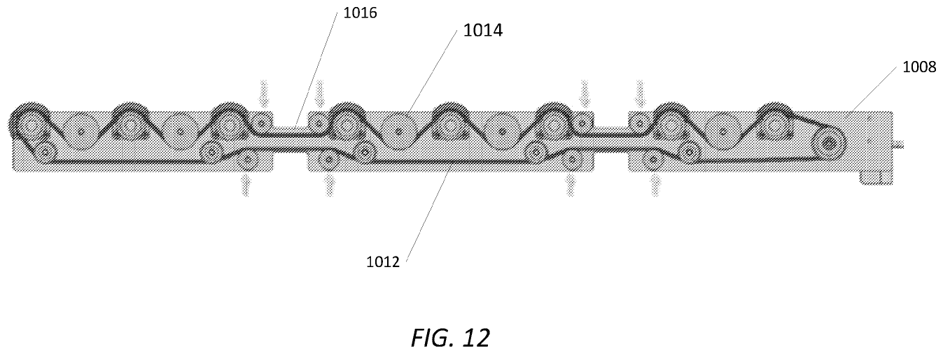

FIG. 12 shows a side view of the acceleration drive mechanism 604 showing belt 1012 disposed around a series of pulleys 1014 to provide the force to rotate axles 1006. Notches 1016 in frame 1008 allow space for the side shift drive mechanism 606, discussed next, to integrate with the acceleration drive mechanism 604.

### Side Shift Drive Mechanism

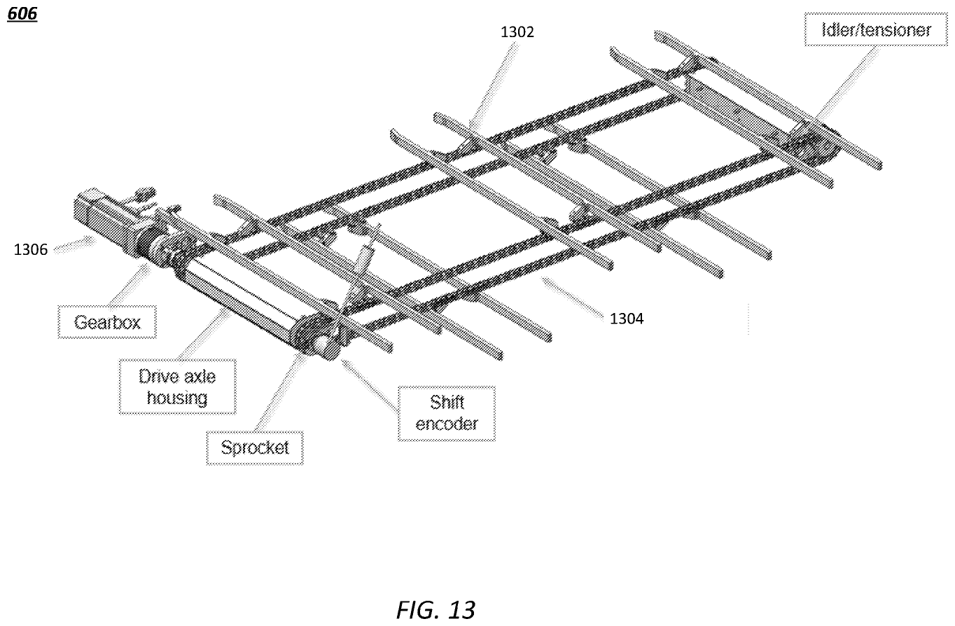

FIG. 13 shows the side shift drive mechanism 606. The purpose of side shift drive mechanism 606 is to push totes 400 from one row on carrier 106 to another row on carrier 106. It should be noted that side shift drive mechanism 606 can be of any length, depending upon the length of carrier 106, and may be capable of shifting totes 400 multiple rows.

Side shift drive mechanism 1300 consists of a set of grousers 1302 driven by a belt or chain 1304. Belt or chain 1304 is driven by motor 1306 via a drive axle. Grousers 1302 move to engage the sides of totes 400 and push the totes 400 in either of the directions indicated by arrow “Z” in FIG. 4. Grousers 1302 are indicated by vertical lines shown in each of FIGS. 3(a-k). Side shift drive mechanism 606 integrates with two or more acceleration drive mechanisms 1000. Chain or belt 1304 fits into slots 1016, shown in FIG. 12.

### Tote Input/Output

In addition to retrieval, storing and shuffling of totes, the storage structure must be capable of outputting a tote from storage structure 100 and intaking a tote into the storage structure 100. In one embodiment, outputting a tote from the storage structure 100 is accomplished by delivering the tote to an output row in the layer of storage system having a downward slope which allows the tote to be gravity fed to either a vertical conveyor located near a pick station of the storage system 100 or to a carrier on a lower level of storage structure 100 which can deliver the tote to the vertical conveyor or, alternatively, to another downward sloped row. In other embodiments, the tote may be output from storage structure 100 by moving it to a level output row having a powered component for moving the tote along the row. Inputting a tote into the storage system is accomplished by delivering the tote via the vertical conveyor to a row in a layer of storage system 100 one layer above the intended target layer and inserting the tote in a row having a downward slope which allows the tote to be gravity fed to the target layer. In certain embodiments of the invention, the gravity feed is accomplished by a row having a slope of approximately 2.5° degrees, however, other degrees of slope may be used.

One possible embodiment of such an intake/output structure is shown in FIG. 1 as reference 108, which shows the intake/output structure located at the end of storage structure 100. As would be realized by one of skill in the art, the intake/output structure 108 could be located at any row 102 within the layer of storage structure 100 and, in fact, the intake/output structure 108 could be located in different rows for different layers of storage structure 100.

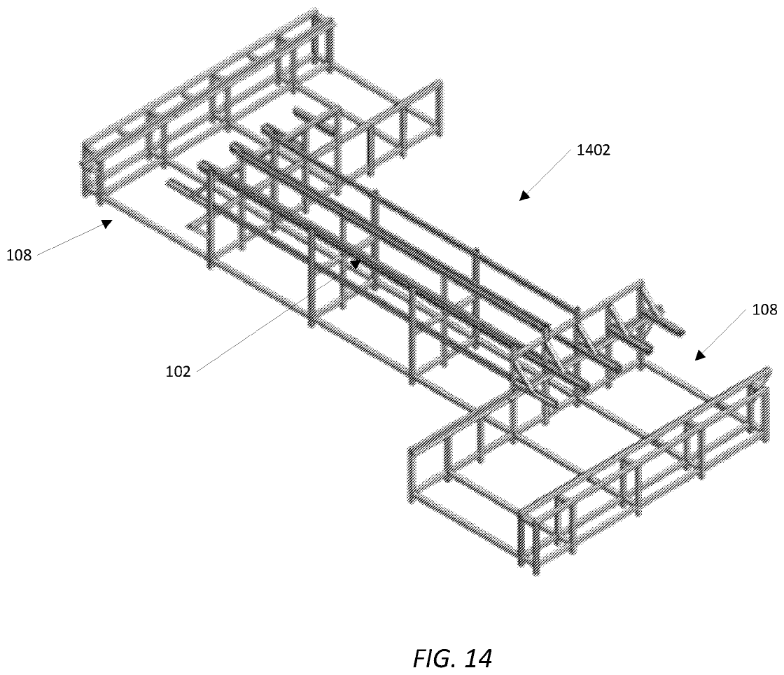

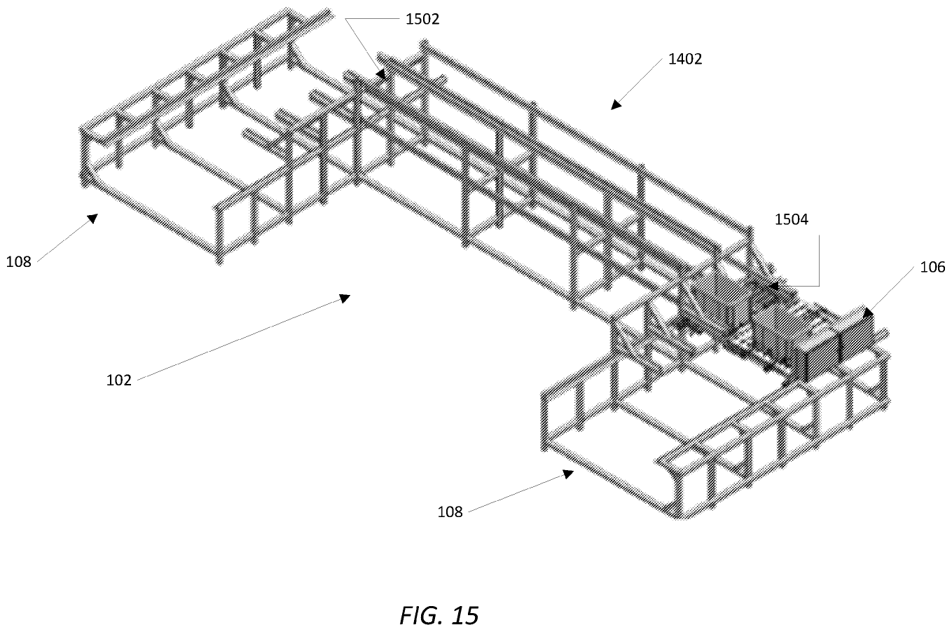

FIG. 14 shows a portion of storage structure 100 having storage rows 102 and carrier servicing areas 108 indicated. The area indicated by reference number 1402 is the area for this layer of the storage system wherein the intake/output structure 108 is to be located. FIG. 15 shows one possible embodiment of intake/output structure 108 for a single row of storage structure 100. Intake/output structure 108 includes row 1502 which allows totes from the next highest layer in the storage structure to be gravity fed to the current layer in the storage structure and row 1504 which allows totes at the current layer is in the storage structure 100 to be gravity fed to the next lowest layer in the storage structure 100. As such, there are two ways to intake and output totes from the storage structure. The first method for outputting totes is a layer-by-layer method in which totes are gravity fed to the next lowest layer and transferred via carrier 106 to another row in the storage structure which in turn gravity feeds the tote to the next lowest layer in the storage structure, until the tote has reached the lowest layer of the storage structure, where it is transferred to a pick station. The second method is by inserting the tote into a row which gravity feeds the tote to a vertical conveyor which then transports the tote to the level of the storage structure and, ultimately, to a pick station.

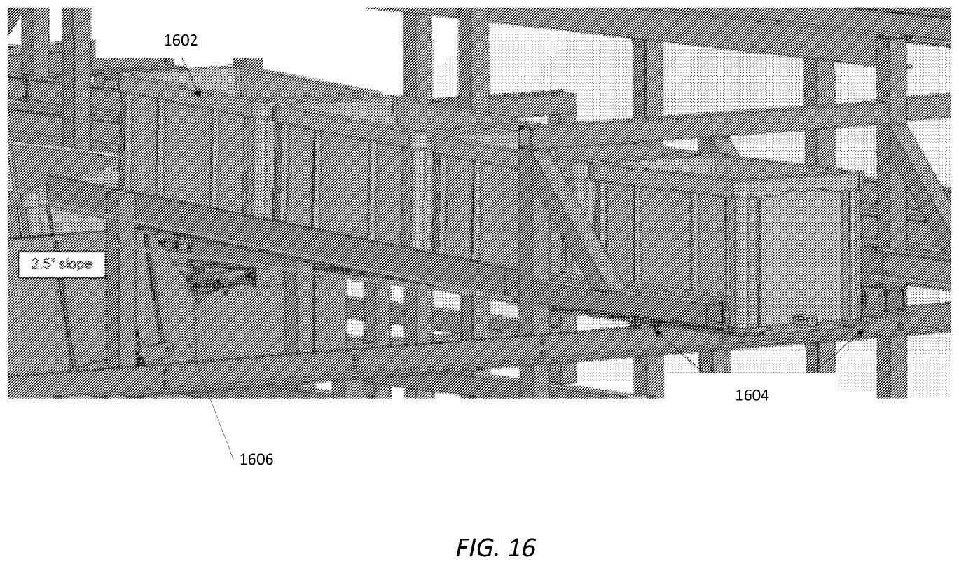

FIG. 16 shows an exemplary intake row of storage structure 100. Totes may be lifted from a pick station by lifting mechanism 1606 to the intake row 1602 and queued within the intake row 1602 until a carrier 106 can load the end tote and transport it to a vertical conveyor, which then lifts the tote to its destination layer (or to a layer above the target layer where the tote is inserted into a downward sloped row to gravity feed the tote to its target layer). It should be noted that while totes are queued in intake row 1602, and because the totes are gravity fed within the row, the end tote must be retained by a retaining mechanism 1604 until a carrier 106 is available to remove the tote from intake row 1602. The retention mechanism 1604 will be discussed later.

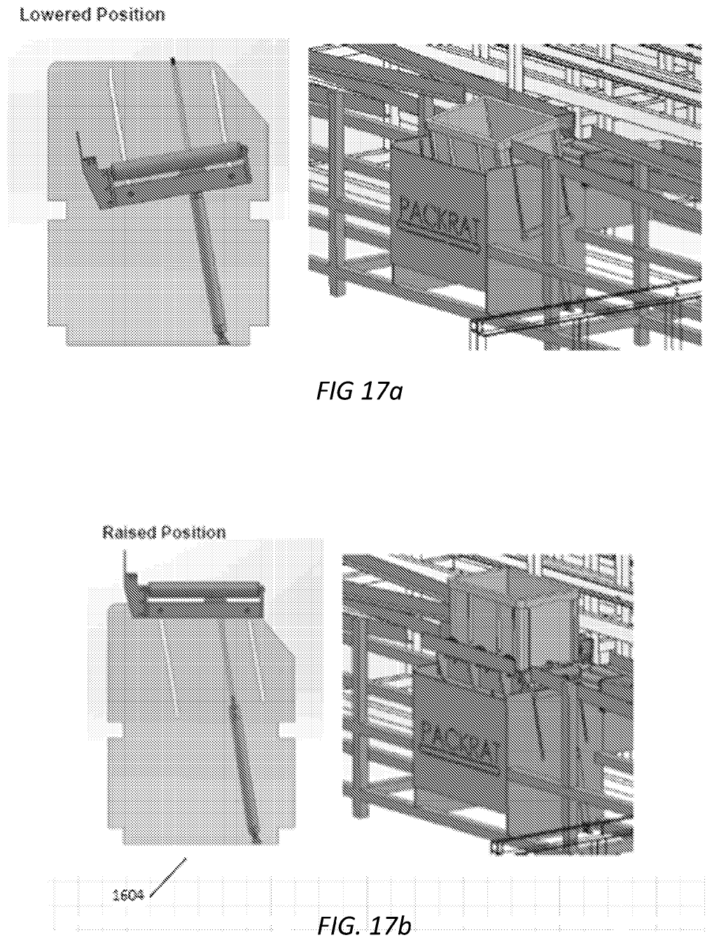

FIGS. 17(a-b) show one possible embodiment of a lifting mechanism 1606 which lifts the tote from a pick station to an intake row 1602 for input to the storage system 100. The tote is placed into the lifting mechanism 1606, which is shown in its lowered position in FIG. 17a. The tote is then raised, as shown in FIG. 17b to a level where it can be pushed into intake row 1602. The lifting mechanism 1606 shown in FIGS. 17(a-b) is exemplary and only and, as would be realized, many other possible configurations of lifting mechanism 1606 are possible without departing from the scope of the invention.

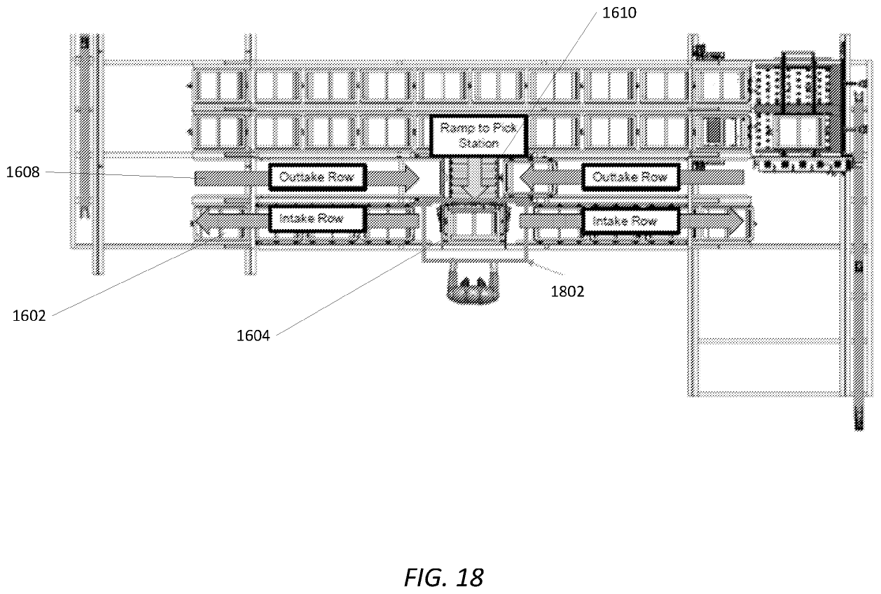

FIG. 18 shows an overhead view of an intake and output row of storage structure 100 at the lowest level with the pick station 1802 is located. To intake a tote in the storage system 100, the worker places the tote in lifting mechanism 1606, which lifts the tote to the level of intake row 1602. Once the tote is queued within intake row 1602, it is gravity fed downward until carrier 106 is available to pick the tote and transport it to vertical conveyor which lifts the tote to the higher layers of the storage system 100.

To output a tote from storage system 100, carrier 106 retrieves the tote either from a downward sloping row within the storage system or from a vertical conveyor and delivers it to output row 1608, where it is gravity fed via a series of rollers 1610 to pick station 1802, where it is retrieved by a worker and removed from storage system 100.

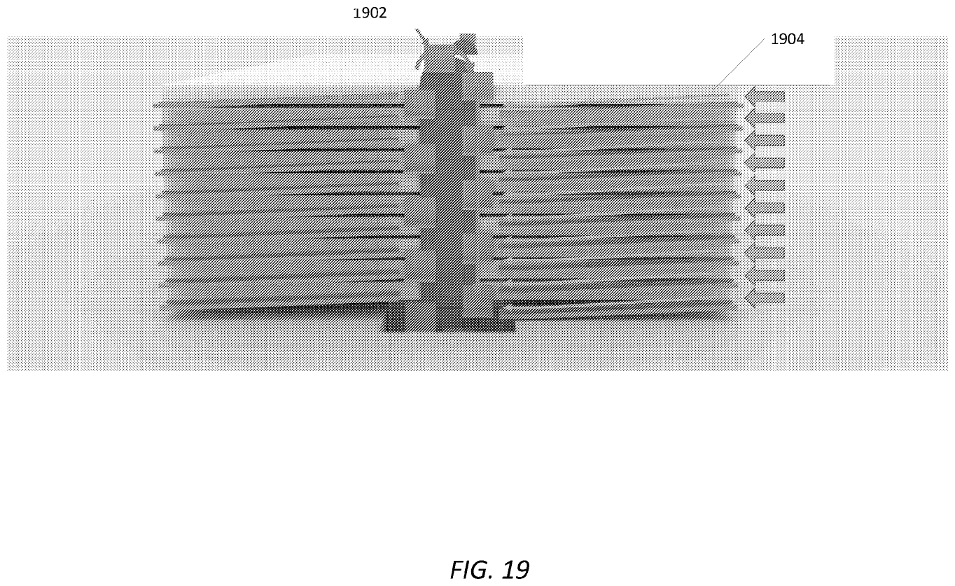

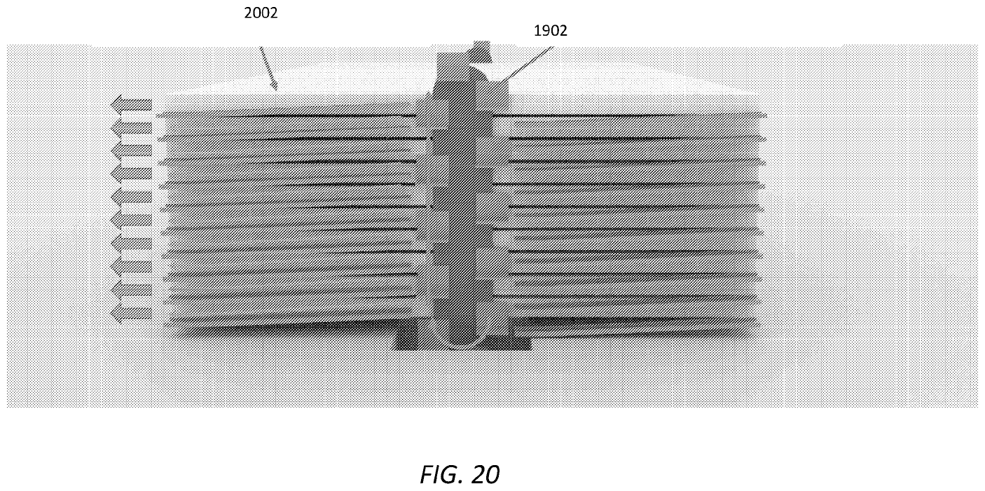

FIGS. 19-20 shows one exemplary embodiment of an intake/output structure 108. In this embodiment, totes are moved vertically via vertical conveyor 1902. When the tote is output from the system, it is placed on the end of one of output buffer ramps 1904 and moves by gravity feed down output buffer ramp 1904, where it is queued until a space on vertical conveyor 1902 becomes available. The totes must be retained at the end of output buffer ramp 1904 until an empty slot on vertical conveyor 1902 can be aligned with the end of output buffer ramp 1904. The vertical conveyor 1902 then moves the tote to the lowest level storage structure 100 where it is conveyed to a pick station 1802.

The input buffer ramp 2002 is shown in FIG. 20. Totes are lifted from the lowest level of storage structure 100 to a level one above the desired target level. The tote is pushed off of conveyor 1902 onto one of input buffer ramps 2002, where it moves by gravity feed down the ramp, where it waits in the queue to be picked up by a carrier 106 and delivered to the target row within the layer. As with the output buffer ramps 1904, when the tote reaches the end of input buffer ramp 2002, a retention mechanism must hold the tote in place until a carrier is available to remove the tote from the bottom of the ramp.

As be realized by skill in the art, the intake/output structure 108 may be located at any position on the end of or within the storage structure 100.

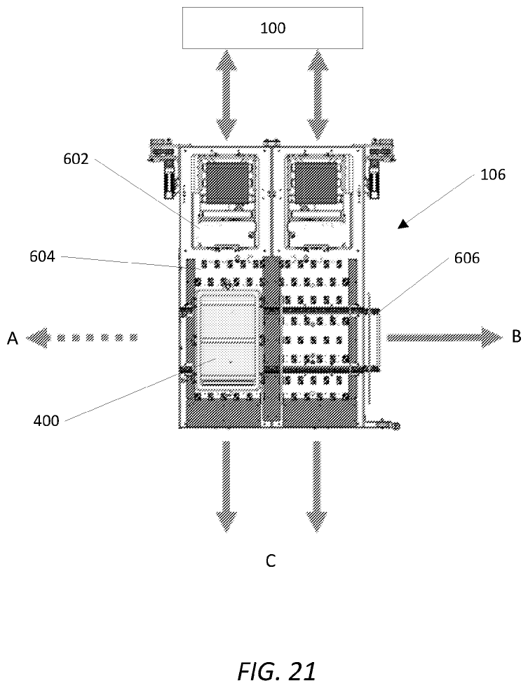

In one embodiment, the output of totes 400 from storage structure 100 may be accomplished by offloading the tote from carrier 106 to an output destination. Such an arrangement is shown in FIG. 21. Carrier 106 can move totes 400 to or from storage structure 100 using constant velocity driver mechanisms 602. Once a tote 400 is fully on carrier 106, instead of moving the tote 400 to another row within storage structure 100, the tote may be offloaded from carrier 106 to, for example, a conveyor belt, another carrier or any other possible destination. Once the tote 400 is fully on carrier 106, it may be offloaded in either of directions “A” or “B” using side shift mechanism 606. Alternatively, tote 400 may be moved in direction “C” from either the left or right rows utilizing acceleration drive mechanism 604.

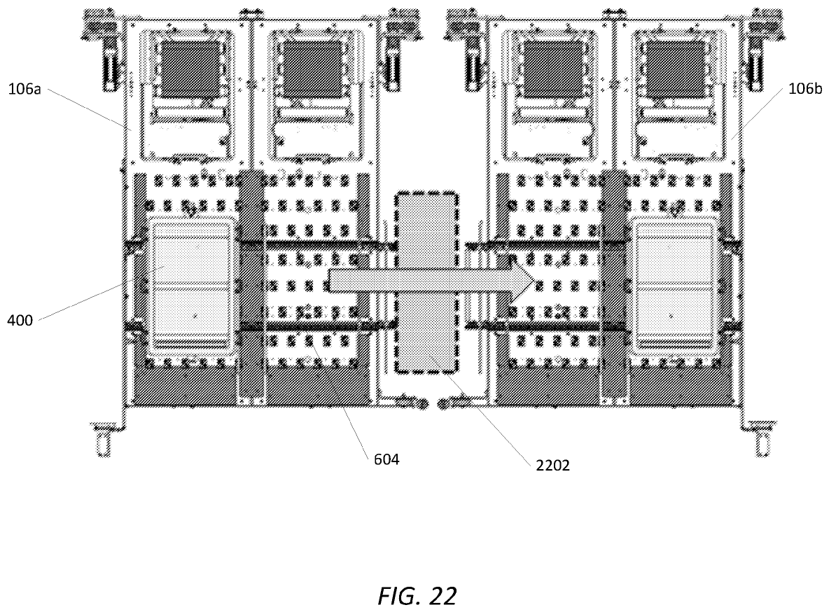

FIG. 22 shows an example of the movement of a tote 400 from a first carrier 106a to a second carrier 106b using side shift mechanism 604. In one embodiment, tote 400 may be required to cross transition area 2202 between carrier 106a and 106b. Transition area 2202 may be, for example, a low friction area, in which case tote 400 may be pushed by side shift mechanism 604 and make cross transition area 2202 by virtue of it's own momentum. In other embodiments, transition area 2202 may be provided with a series of Omni casters 1002 to reduce the friction between transition area 2202 and tote 400. In some embodiments, transition area 2202 may be provided with its own side shift mechanism 604. In some embodiments, transition area 2202 may be a part of either of carriers 106a or 106b. In other embodiments, transition area 2202 may be stationary and disposed between the areas of storage structure 100 covered by carriers 106a and 106b respectively. In this case, carriers 106a and 106b may need to move to transition area 2202 to accomplish the transfer. In yet other embodiments, transition area 2202 may be eliminated and carriers 106a, 106b may be able to move close enough to each other to accomplish the transfer. In any case, as tote 400 and moves from first carrier 106a to second carrier 106b, it is desirable that the side shift mechanism 604 both carriers be moving at the same speed.

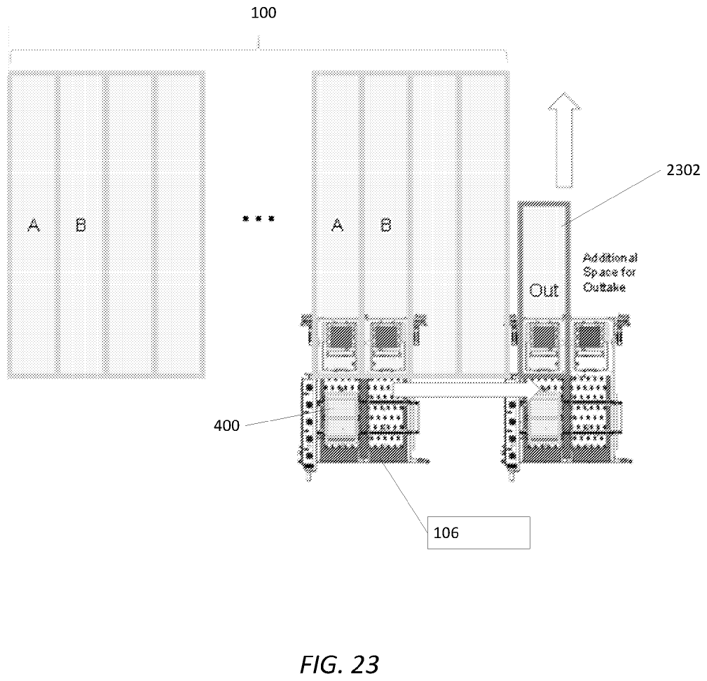

As previously mentioned, a tote 400 may be output from storage system 100 by virtue of a series of downward-sloping ramps. FIG. 23 shows such an arrangement and the delivery of a tote 400 from row “A” in storage structure 100 to output ramp 2302. In this scenario, tote 400 is loaded onto carrier 106 as previously described using constant velocity drive mechanism 602. The tote then moves laterally to downward-sloping output row 2302, where the tote is accelerated toward output row 2302 by acceleration drive mechanism 604 and moved into output row 2302 by constant velocity drive mechanism 602. Once tote 400 has been completely offloaded from carrier 106, it is gravity fed downward row 2302 where it may be retained at the end of row 2302 by a retention mechanism 1604. Once at the end of output row 2302, the tote 400 may be offloaded to, for example, a horizontal or vertical conveyor, as previously described. In various embodiments, either the left row or the right row on carrier 106 may align with output row 2302. In the scenario shown in FIG. 23, tote 400 is loaded from row “A” of storage structure 100 into the left row of carrier 106 and the left row of carrier 106 is aligned with output row 2302. Is also possible that tote 400 could be transferred to the right row of carrier 106, whereupon the right row of carrier 106 would align with output row 2302. This method of outputting totes from storage structure 100 has the advantage of not requiring additional mechanisms (for example, conveyors) to transfer totes laterally.

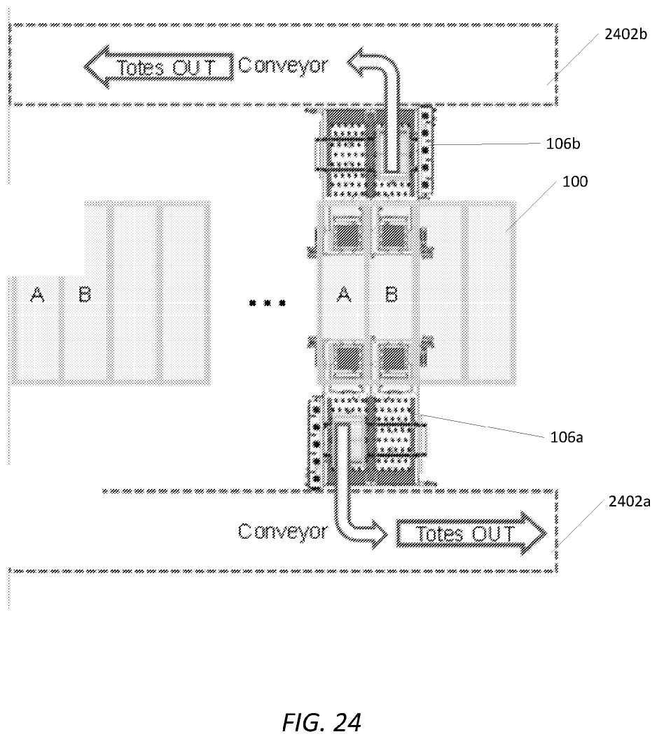

FIG. 24 shows yet another scenario for outputting a tote 400 from storage structure 100. In this case, storage structure 100 is configured with conveyors 2402a, 2402b located on opposite sides thereof. In this case, carrier 106a removes the tote from row “A” of storage structure 100 and delivers it via the scenario described with respect to FIG. 21 to conveyor 2402a. Likewise, carrier 106b may remove a tote from row “B” of storage structure 100 and deliver it to conveyor 2402b. In various embodiments of the invention, storage structure 100 may be provided with conveyors on one or both ends of the rows. In addition, in various embodiments, conveyors 2402a and 2402b may move in opposite directions or may move in the same direction. In yet other embodiments, conveyors 2402a and 2402b may change directions, depending on the situation. Lastly, in various embodiments, it is not necessary that either of carriers 106a or 106b be stationary when transferring tote 400 to the conveyor. The delivery of tote 400 to may occur as carrier 106a, 106b is in motion, for example, in the process of moving to another row within the layer of storage structure 100.

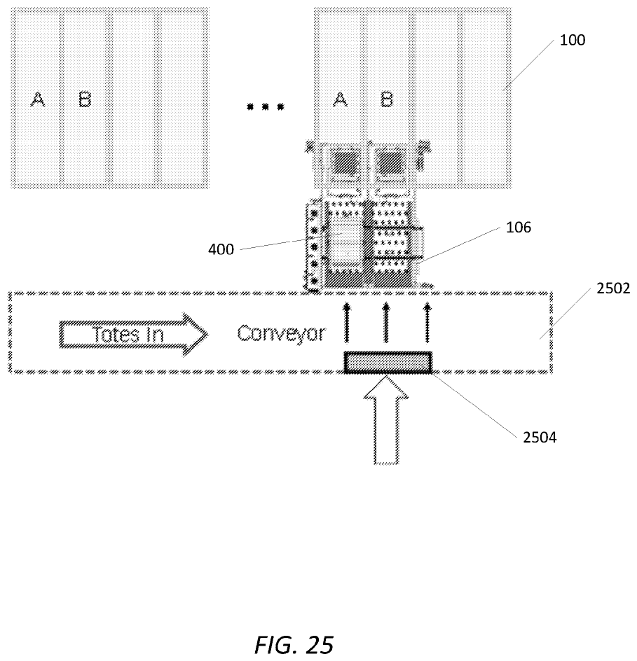

Conveyors located on one or both sides of storage structure 100 may also be used to intake totes into storage structure 100 as shown in FIG. 25. Totes 400 may be fed onto conveyor 2502 by any known means. At any point along conveyor, tote 400 may be pushed onto a carrier 106 by push mechanism 2504. In one embodiment wherein carrier 106 is stationary carrier 106, it would be desirable that the speed of side shift mechanism 606 on tote 106 match the speed of conveyor 2502. In another embodiment, carrier 106 may accept the transfer of tote 400 as it is moving, in which case is desirable to match the speed of conveyor 106 with the speed of conveyor 2502. Once tote 400 has been fully loaded onto carrier 106, carrier 106 may stop at any row within storage structure 100 to insert tote 400 into the row.

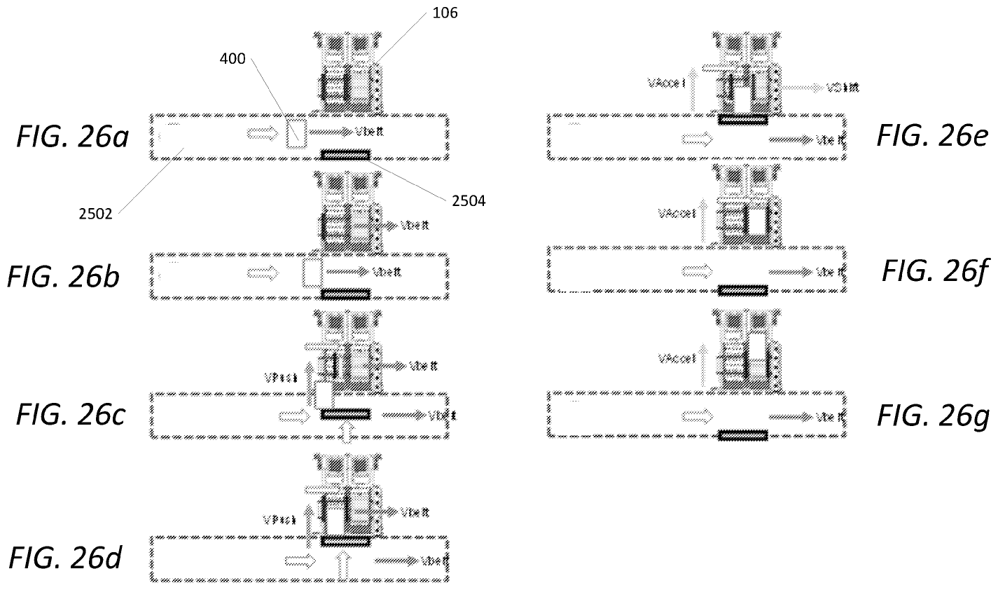

FIGS. 26(a-g) show a series of steps for transferring tote 400 from conveyor 2502 to carrier 106. Table 1 below shows the state of each of the components during the process. In FIG. 26a, tote 400 is proceeding along conveyor 2502, which is preferably moving at a constant velocity. In FIG. 26b, tote 400 is approaching carrier 106 to which it is to be loaded. In preparation for accepting tote 400, the speed of side shift mechanism 606 on carrier 106 is adjusted to match the speed of conveyor 2502. In FIG. 26c, pusher 2504 begins to push tote 400 toward carrier 106. Preferably, pusher 2504 begins to push tote 400 such as to align tote 400 between growsers 1302 of side shift mechanism 606. In addition, the speed of acceleration drive mechanisms 604 in both the left and right rows of carrier 106 should match the velocity of pusher 2504. In FIG. 26d, tote 400 has been completely loaded onto carrier 106. At this point, pusher 2504 comes to a stop. In FIG. 26e, side shift mechanism 606 is moving tote 400 from the left row to the right row of carrier 106 and at the same time the acceleration drive mechanisms 604 in both the left row and the right rows of carrier 106 are moving toward storage structure 100. In FIG. 26f, pusher 2504 retracts to the opposite side of conveyor 2502 and tote 400 is fully loaded onto carrier 106. FIG. 26g shows tote 400 being loaded into storage structure 100 by carrier 106, however, as would be realized, carrier 106 may delay moving tote 400 into storage structure 100 until tote is aligned with the desired destination row.

TABLE 1

| Step | Belt | Pusher | Side Shift | Accelerator |
|---|---|---|---|---|
| A | Constant | Stopped | Stopped | Stopped |
| | Velocity | | | |
| | (Vbelt) | | | |
| B | Constant | Stopped | Match Belt | Stopped |
| | Velocity | | Velocity | |
| | (Vbelt) | | | |
| C | Constant | Constant | Constant | Match |
| | Velocity | Velocity | Velocity | Pusher |
| | (Vbelt) | (Vpush) | (Vbelt) | Velocity |
| D | Constant | Constant | Constant | Constant |
| | Velocity | Velocity | Velocity | Velocity |
| | (Vbelt) | (Vpush) | (Vbelt) | (Vpush) |
| E | Constant | Stopped | Constant | Constant |
| | Velocity | | Velocity | Velocity |
| | (Vbelt) | | (Vbelt) | (Vpush) |
| F | Constant | Retract to | Stopped | Constant |
| | Velocity | Original | (Aligned | Velocity |
| | (Vbelt) | Position | to Row) | (Vpush) |
| G | Constant | Stopped | Stopped | Constant |
| | Velocity | | (Aligned | Velocity |
| | (Vbelt) | | to Row) | (Vpush) |

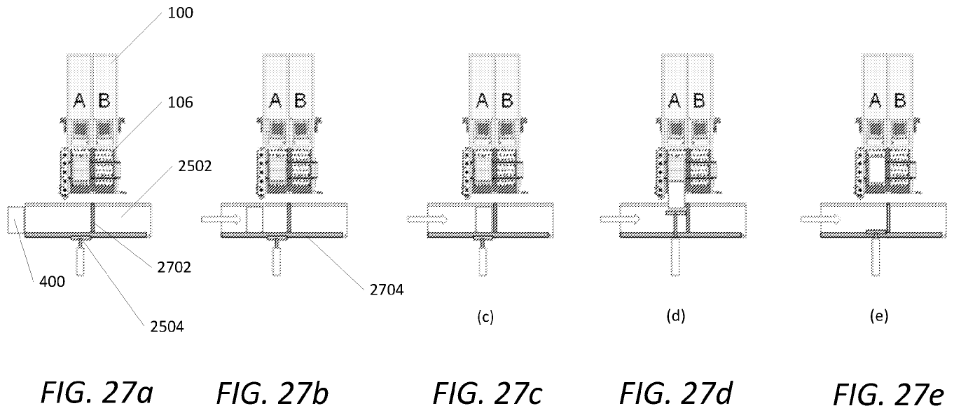

FIGS. 27(a-e) show an alternate embodiment of a method of aligning a tote with a row in carrier 106 such as to be able to push the tote from conveyor 2502 onto carrier 106. In this embodiment, tote 400 is stopped from moving with conveyor 2502 via fixed stopper plate 2702. In various embodiments, a low friction interface between tote 400 and conveyor 2502 may be provided to allow conveyor 2502 to continue its motion even though tote 400 has been stop by stopper plate 2702. Stopper plate 2702 holds tote 400 in alignment with a row (either left or right row) of carrier 106 until pusher 2504 can push tote 400 into the row on the carrier. In other embodiments, conveyor 2502 may stop once tote 400 contacts stopper plate 2702. In FIG. 27a, tote 400 is loaded onto conveyor 2502 from any source. At FIG. 27b, conveyor 2502 may be provided with rear backer plate 2704 to maintain alignment of tote 400 as it traverses conveyor 2502. At FIG. 27c, stopping plate 2702 stops the forward progress of tote 400 and aligns it for loading onto a row of carrier 106. At FIG. 27d, pusher 2504 pushes tote 400 on to carrier 106 and, at FIG. 27e, acceleration drive mechanism 604 accelerates tote 400 toward storage structure 100. There are at least three possible embodiments for stopper plate 2702. In a first embodiment, each row of storage structure 100 is provided with a stopper plate 2704 that may be moved into and out of position such as to stop a tote 400 or to allow the tote 400 to pass. In the second embodiment, conveyor 2502 may be provided with one or more stopper plates 2702 that move with the conveyor 2502. In the third embodiment, stopper plate 2702 may be attached to carrier 106 and may move with carrier 106.

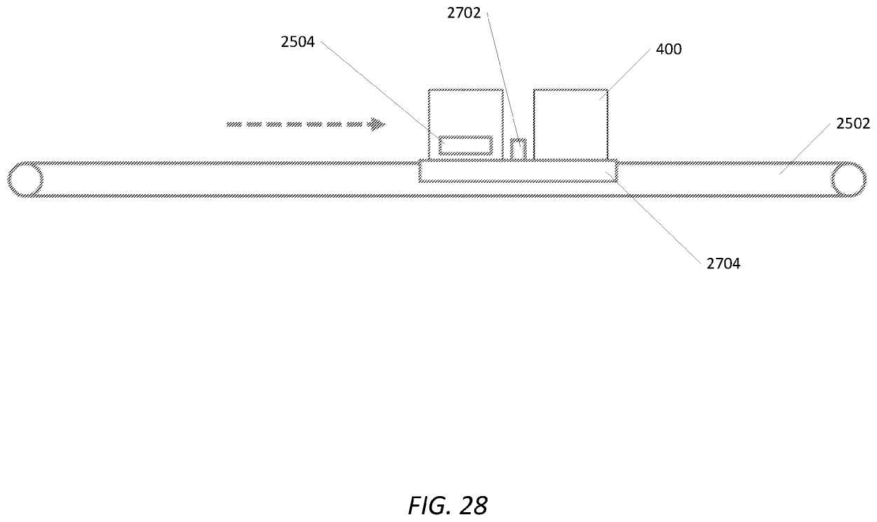

FIG. 28 shows one embodiment of the configuration described with respect to FIGS. 27(a-e) in which the components are attached to carrier 106 and move with the carrier as the carrier moves back and forth with respect to storage structure 100 and conveyor 2502. FIG. 28 shows an embodiment wherein backer plate 2704, stopper plate 2702 and pusher 2504 are connected to carrier 106 via a portion of carrier 106 which extends above conveyor 2502. However, in alternate embodiments, backer plate 2704, stopper plate 2702 and/or pusher 2504 may connected to the carrier 106 via a portion of carrier 106 which extends underneath of conveyor 2502. Also, it should be noted that pusher 2504 is shown on the left row of carrier 106, however, as would be realized by one of skill in the art, multiple pushers may be provided on carrier 106, for example, one for each row of carrier 106, or for selected rows of carrier 106, in the event that carrier 106 is multiple rows in width. As such, with respect to carrier 106 shown in FIG. 28, pusher 2504 could alternatively be located on the right row of carrier 106.

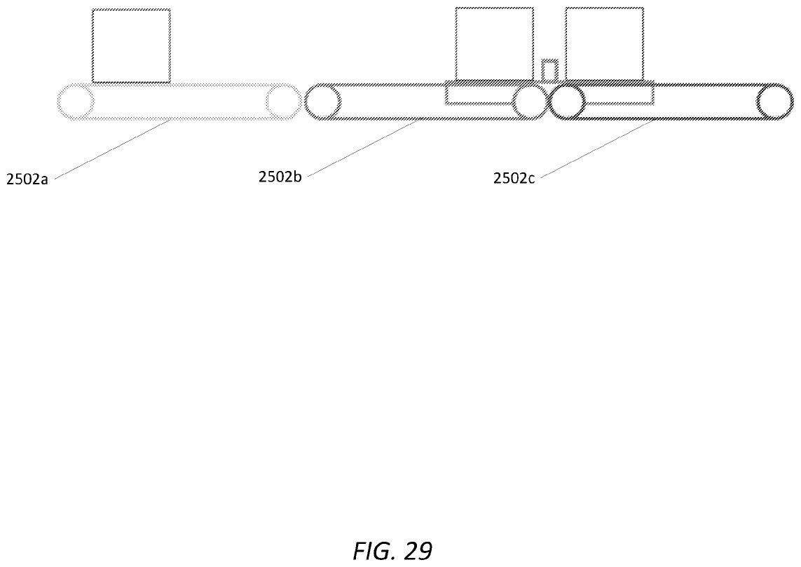

FIG. 29 shows yet another embodiment wherein conveyor belt 2502 may be segmented, for example, in the segments 2502a, 2502b and 2502c. In this case, the embodiment described with respect FIG. 28 wherein backer plate 2704, stopper plate 2702 and pusher 2504 are connected to carrier 106 is able to accommodate the segmented conveyor.

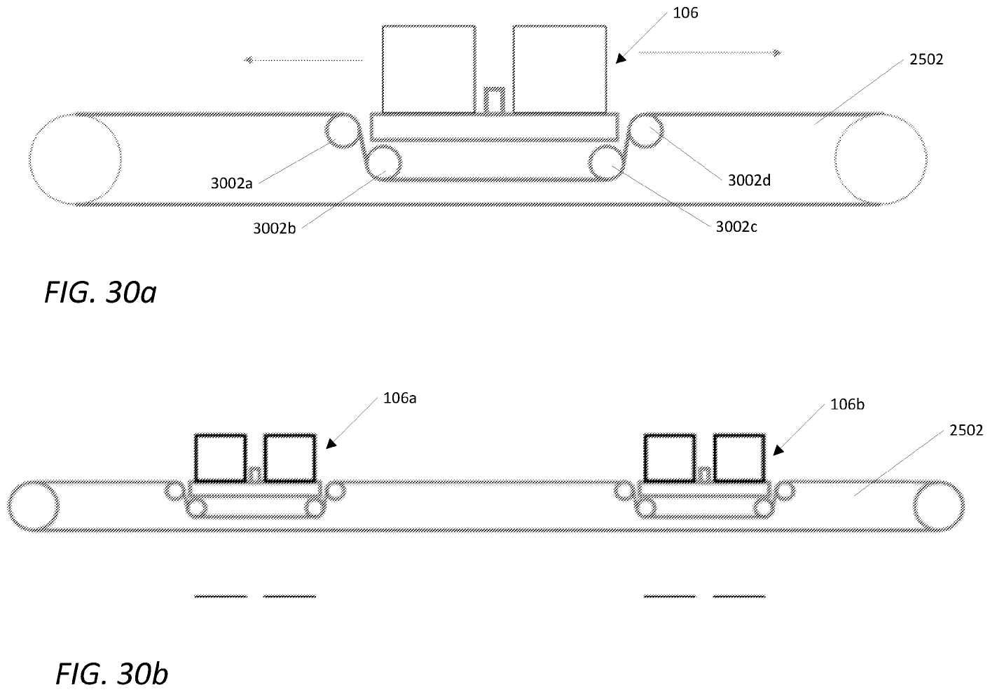

FIG. 30a shows yet another embodiment wherein carrier 106 is provided with a series of pulleys 3002(a-d) which engage the belt portion of conveyor 2502 and allow the carrier to move with respect to conveyor 2502 even if conveyor 2502 is in motion in either direction. Preferably the belt portion of conveyor 2502 is aligned with the side shift mechanism 606 of carrier 106, such that the side shift mechanism 606 may be used to move totes 400 from carrier 106 onto conveyor 2502 and from conveyor 2502 onto carrier 106. Therefore, preferably the side shift mechanism 606 of carrier 106 moves at a velocity that matches the velocity of conveyor 2502. FIG. 30b shows yet another embodiment wherein multiple carriers 106 may be disposed on the conveyor 2502 to allow for complete freedom of movement of one or more carriers 106 anywhere along the length of conveyor 2502. This config also allows for the ability to shift totes from a first carrier 106a to a second carrier 106b by unloading the tote from carrier 106a, allowing the tote to move to carrier 106b along the conveyor 2502 and then loading the tote onto carrier 106b. As would be realized by one of skill in the art, any number of carriers 106 may be disposed along conveyor 2502 in the configuration shown in FIG. 30b.

### Tote Retention Mechanism

Anytime a tote is placed on a downward sloping ramp, whether it be an intake ramp or an output ramp, the tote is gravity fed to the bottom of the ramp, where it must be retained until a carrier 106 is available to remove it from the end of the row. As such, a tote retention mechanism 1604 must be provided at the bottom of each sloped ramp. In some embodiments wherein storage structure 100 is not level, retention mechanisms can be added to each row to maintain totes within the storage structure.

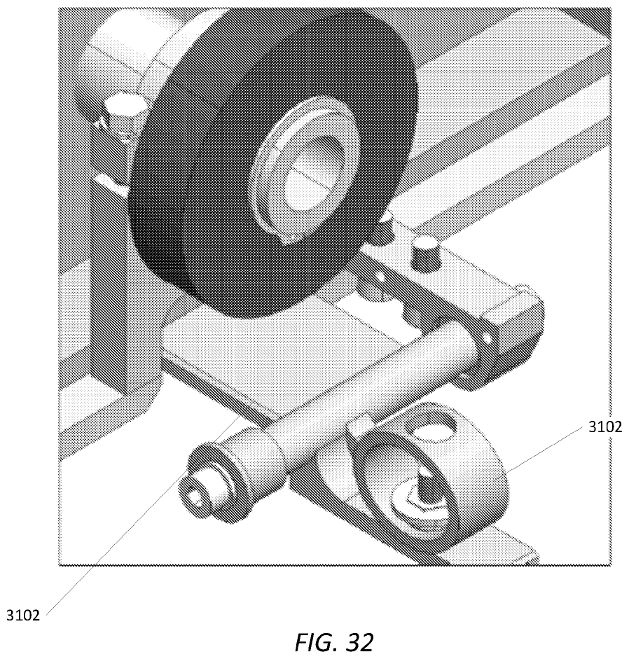

One possible embodiment of the tote retention mechanism 1604 is shown in FIG. 31a. The retention mechanism 1604 comprises a rotating gate 3102 which pivots to either block the tote from proceeding in a first state or to allow the tote to proceed in a second state. In the first state, wherein the tote is prevented from proceeding, the rotating gate 3102 is held in place by locking magnet 3104. When retention mechanism 1604 switches to the second state to allow the tote to pass, the rotating gate 3102 is nudged from contact with locking magnet 3104 by push mechanism 3106, shown in FIG. 31b. When the push mechanism 3106 retracts, rotating gate 3102 is again rotated into contact with locking magnet 3104 by spring 3108. Retention mechanism 1604, as shown in FIGS. 31(a-b) is shown in the second state, wherein the tote is allowed to pass. FIG. 31b shows mechanism 1604 in situ. As may be realized, a retention mechanism 1604 may be located at both sides of the track, such that both ends of the tote are retained equally to prevent skewing of the tote. Retention mechanism 1604 is shown in its first state in FIG. 32 where the rotating gate 3102 is engaged with the bottom of the tote to prevent movement of the tote off of the sloped ramp.

### Shifting Mechanism

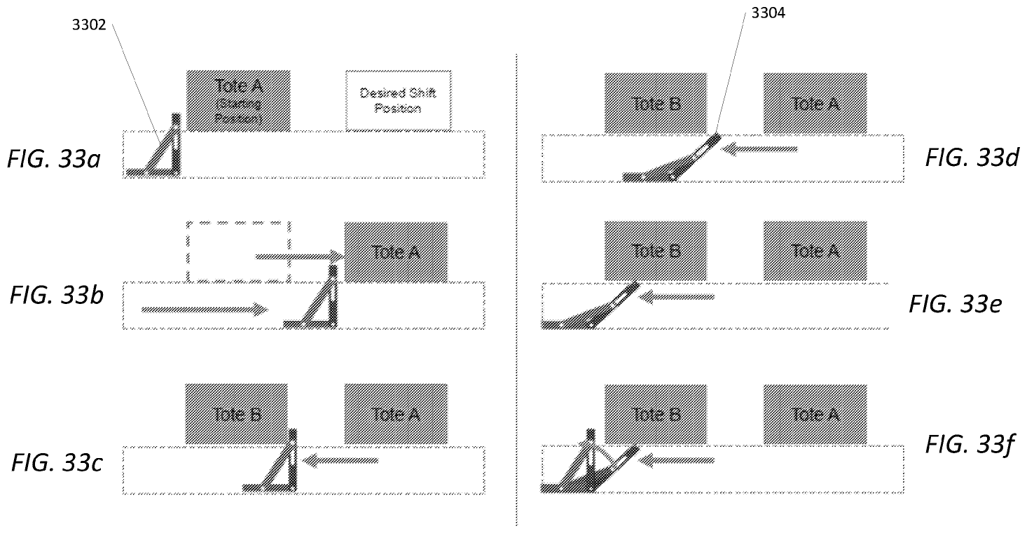

It may, at times, be necessary to shift tote from a first position to a second position, for example, when shifting a tote from the pick station lift mechanism 1606 to the input ramp. FIGS. 33(a-f) show a spring-loaded push mechanism 3302 for accomplishing the shifting of a tote. FIG. 33a, shows tote “A” in a first position, the desired position and push mechanism 3302. In FIG. 33b, push mechanism 3302 has pushed tote “A” to the desired position. FIG. 33c shows that tote “B” has replaced tote “A” and it is now desired to push tote “B” into the position now occupied by tote “A”. Push mechanism 3302 moves backward and, as it contacts tote “B”, as shown in FIGS. 33(d-e), the spring-loaded head 3304 of push mechanism 3302 bends forward to allow clearance around tote “B”. As shown in FIG. 33f, as push mechanism 3302 reaches the end of tote “B”, the spring-loaded head 2304 springs back up and pushing mechanism 3302 is now ready to push tote “B” into the desired position. As would be realized by one of skill in the art, many other variations of push mechanism 3302 may be possible and are contemplated to be within the scope of the invention.

### Storage System Configurations

The invention has been described in terms of a carrier 106 having a particular configuration, namely, two rows wide with two constant velocity drive mechanisms 602, two acceleration drive mechanisms 604, and a single side shift drive mechanism 606. In addition, carrier 106 is mobile, allowing movement from row to row within the layer. However, many other configurations are possible.

In one embodiment, carrier 106 may be more than two rows wide. In such a configuration, carrier 106 would be equipped with a constant velocity drive mechanism 602 for each row and a acceleration drive mechanism 604 for each row, in addition to a single side shift drive mechanism 606. In this configuration, carrier 106 would be mobile.

In one embodiment, each layer of storage structure 100 may be zoned, wherein each zone is serviced by a non-mobile carrier 106 and wherein each carrier 106 is as wide as the zone that it services and is equipped with a constant velocity drive mechanism 602 for each row, a acceleration drive mechanism 604 for each row, and a single side shift drive mechanism 606. In this case it is necessary for carrier 106 to be able to move totes to an adjacent carrier 106.

In one embodiment of the invention, each layer of storage structure 100 may be provided with a single non-mobile carrier which is as wide as the layer of the storage structure 100. In this embodiment, each carrier 106 is equipped with a single constant velocity drive mechanism 602 for each row, a single acceleration drive mechanism 604 for each row, and a single side shift drive mechanism 606.

As be realized by one of skill in the art, carriers 106 are disposed on opposite ends of storage structure 100. In various embodiments, each side of the storage structure 100 may be configured differently in accordance with one of the embodiments of carriers noted above.

In one embodiment, the storage structure 100 may be provided with an intake/output structure on one or both ends thereof, as shown in FIG. 1.

In one embodiment of the invention, the storage structure 100 may be provided with an intake/output structure that comprises sloped ramps located on any row of each layer.

In one embodiment of the invention, the storage structure 100 may be provided with an intake/output structure that comprises sloped ramps located in different rows of each layer.

In one embodiment, the storage structure 100 may be provided with internal, sloped ramps at the lowest level that transport totes from the sloped ramps to a pick station.

In one embodiment, the storage structure 100 may be provided with one or more vertical conveyors 1902 for moving totes vertically within the storage structure 100.

The invention has been described in the context of specific embodiments, which are intended only as exemplars of the invention. As would be realized, many variations of the described embodiments are possible. For example, variations in the design, shape, size, location, function and operation of various components, including both software and hardware components, would still be considered to be within the scope of the invention, which is defined by the following claims.

1. A storage structure comprising:
a plurality of layers, each layer comprising a plurality of rows for storing a plurality of totes;
one or more carriers located on opposite ends of each layer, each carrier being multiple rows wide, each carrier comprising:
two or more constant velocity drive mechanisms, one corresponding to each of the multiple rows;
two or more acceleration drive mechanisms, one corresponding to each of the multiple rows; and
a side shift drive mechanism.

2. The storage structure of claim 1 wherein the one or more carriers are mobile within a single layer of the storage structure.

3. The storage structure of claim 1 wherein the constant velocity drive mechanism comprises a motor driven conveyor belt for frictionally engaging a tote.

4. The storage structure of claim 1 wherein the constant velocity drive mechanism comprises a mechanism for mechanically engaging a tote.

5. The storage structure of claim 4 wherein the constant velocity drive mechanism comprises a lifting mechanism to lift the motor driven conveyor belt into the frictional engagement with the tote.

6. The storage structure of claim 1 wherein the constant velocity drive mechanisms move a row of totes into or out of a row at a constant velocity.

7. The storage structure of claim 6 wherein the side shift drive mechanism shifts a tote from one row on the carrier to another row on the carrier.

8. The storage structure of claim 7 wherein shifting a tote from one row in the carrier to another row in the carrier comprises moving the tote in a direction orthogonal to a longitudinal line of the row from which the tote was removed.

9. The storage structure of claim 8 wherein moving the tote in the orthogonal direction causes passive decoupling of the tote from other totes in the row.

10. The storage structure of claim 7 wherein the acceleration drive aligned with the row from which the tote is being removed matches the speed of the constant velocity drive mechanism.

11. The storage structure of claim 10 wherein the acceleration drive mechanism aligned with the row in which the tote is being placed accelerates the tote into the row such as to cause a coupling of the tote with a tote in the row.

12. A storage structure comprising:
a plurality of layers, each layer comprising a plurality of rows for storing a plurality of totes; and
a plurality of totes disposed within the plurality of rows;
wherein two or more totes within a single row are coupled together.

13. The storage structure of claim 12 wherein each of the plurality of totes comprises a structure having a plurality of wheels thereon, the wheels riding in parallel tracks forming each of the plurality of rows.

14. The storage structure of claim 13 wherein the wheels are disposed toward a bottom of the structure such that the structure is disposed above the tracks.

15. This storage structure of claim 13 wherein the wheels are disposed toward a top of the structure such as the structure is disposed below the tracks.

16. The storage structure of claim 12 wherein each row in the storage structure comprises a plurality of wheels and further wherein each of the plurality of totes comprises a structure engages the plurality of wheels in the row.

17. The storage structure of claim 12 further comprising:
a carrier aligned with each end of a row from which a tote is to be retrieved or to which a tote is to be stored.

18. The storage structure of claim 17 wherein a pulling force is exerted by the carrier on a tote at the end of a row causes the tote at the end of the row to move on to the carrier and further causes totes coupled to the tote at the end of the row to move in a longitudinal direction toward the carrier.

19. The storage structure of claim 18 wherein shifting a tote from a first position on the carrier to a second position on the carrier in a direction orthogonal to a longitudinal line of the row from which the tote was retrieved causes the automatic decoupling of the tote from an adjacent tote within the row.

20. Storage structure of claim 19 wherein an accelerated pushing force is exerted by the carrier on a tote disposed on the carrier causes the tote to move into a destination row and couple with a tote at the end of the destination row.

21. A storage structure comprising:
a plurality of layers, each layer comprising a plurality of rows for storing a plurality of totes;
one or more carriers located on opposite ends of each layer, each carrier being multiple rows wide;
a first set of one or more sloped ramps accessible by the one or more carriers for moving totes retrieved by the carriers to a lower level within the storage structure; and
a second set of one or more sloped ramps accessible by the one or more carriers for receiving totes from a higher level within the storage structure.

22. The storage structure of claim 21 wherein the one or more sloped ramps for moving totes to a lower level in the storage structure move the totes via gravity feed to a vertical conveyor.

23. The storage structure of claim 21 wherein the one or more sloped ramps for receiving totes from a higher level in the storage structure receive the totes from a vertical conveyor and move them via gravity feed to a lower level in the storage structure.

24. The storage structure of claim 21 wherein each sloped ramp in the first and second sets sloped ramps are configured with one or more retention devices at a bottom thereof to prevent totes from prematurely exiting the ramp.

25. The storage structure of claim 21 further comprising a picking station from which totes may be removed from or inserted into the storage system.
